(19) United States
(12) Patent Application Publication
(10) Pub. No.: US 2009/0197486 A1
(43) Pub. Date: Aug. 6, 2009

(54) Method and system for maneuvering aquatic vessels

(75) Inventors: Edmund Alexander Szilagyi, Virginia Beach, VA (US); Christopher John Blanchard, Engelhard, NC (US); Clifton Paul Spencer, JR., Manteo, NC (US)

Correspondence Address: VOLVO TECHNOLOGY OF AMERICA, CORPORATE PATENTS, 7825 NATIONAL SERVICE ROAD, MAIL STOP, AP1/3-41, GREENSBORO, NC, 27409, US

(73) Assignee: AB VOLVO PENTA, Gothenburg (SE)

(21) Appl. No.: 12/012,052

(22) Filed: Jan. 31, 2008

(51) Int. Cl. B63H 5/125; B63H 21/21; G06F 19/00

(52) U.S. Cl. 440/53; 440/84; 701/21

(57) ABSTRACT

An aquatic vessel (500) includes a hull (20) and two engines (30, 50), the engine (30, 50) outputs being rotationally couplable to corresponding propeller units (332, 352) which are mounted so as to be angularly moveable in respect of the hull (20). The vessel (500) includes a control unit (70) for controlling operation of the engines (30, 50) and angles (α₁, α₂) of the propeller units (332, 352) with respect to the hull (20). The vessel (500) is configurable to operate in a first mode wherein directions of thrust developed by the propeller units (332, 352) are mutually substantially parallel for propelling the vessel (500) through water, and a second “fishing” mode of operation wherein the directions of thrust developed by the propeller units (332, 352) are configured to mutually diverge with respect to a longitudinal axis from a rear end of the vessel (500) to a forward end thereof for providing the vessel (500) with a turning characteristic (160) in operation. The control unit (70) is configured to receive in operation user-instructions for commanding the control unit (70) to operate in the second mode for causing the propeller units (3320, 352) to be angularly orientated in a divergent manner in respect of the longitudinal direction. The control unit (70) controls rotation of the vessel (500) by controlling power coupled from the two engines (30, 50) and delivered to their propeller units (332, 352) and forward/reverse coupling of the propeller units (332, 352).

### FIELD OF THE INVENTION

The present invention concerns methods of maneuvering aquatic vessels, for example boats. Moreover, the present invention also relates to aquatic vessels operable pursuant to such methods. Furthermore, the present invention also concerns software products stored on a data carrier or conveyable by a way of a signal, wherein the software products are executable on computing hardware for implementing methods of the invention.

### BACKGROUND OF THE INVENTION

Motorized aquatic vessels such as boats are well known. With regard to competition speed boats, high performance fishing boats and similar types of aquatic vessels for which responsive handling characteristics are highly desirable, methods of providing such boats and vessels with an enhanced degree of maneuverability is highly desirable. For example, when using motorized boats for fishing large sport fish, for example sharks, tuna, or marlins and other billfish, it is highly desirable that the boats can be turned rapidly substantially about their geometrical center. This allows the stern regions of the boats, where fishing apparatus such as booms and winches are conventionally mounted, to be maneuvered towards the fish to assist with capturing such fish and eventually winching them onboard the boats.

Although more powerful boat engines are perceived to be capable of rendering boats more rapidly maneuverable, for example for catching large fish, such larger engines weigh more and tend to offset performance benefits of more powerful engines. Moreover, larger engines can potentially result in high center of gravity for boats which adversely affects their stability in water.

Referring to FIG. 1, a conventional fishing boat 10 adapted for fishing big fish is illustrated schematically in plan view. By “big fish”, it is intended to imply, for example, sharks, marlin, swordfish, tuna and other large sport fish. The boat 10 includes a hull 20 including a front bow region at a top of FIG. 1, a rear stern region at a bottom of FIG. 1, a starboard region to a right-hand side of FIG. 1, and a port-side region to a left-hand side of FIG. 1. The boat 10 has a geometrical center denoted by C. As is typical, the boat 10 has first and second engines (not illustrated) and associated drive units 30, 50 mounted in a fixed non-pivoting manner at the aforesaid stern region. The drive units 30, 50 couple the engines to a respective propeller 32, 52 which can either be implemented in traction (pulling) or pushing modes; in FIG. 1, the propellers 32, 52 are shown in traction mode. The first and second drive units 30, 50 with their associated propellers 32, 52 respectively are shown aligned to axes 40, 60 which are mutually parallel and also parallel to a general longitudinal axis of the boat 10 passing through the bow region to the stern region. Additionally, the first and second drive units 30, 50 are provided with rudders 34, 54 at rear regions thereof. The rudders 34, 54 are pivotally mounted as shown for steering a direction of travel of the boat 10 in view of the drive units 30, 50 being mounted to the hull in fixed angular configuration.

The illustrated exemplary boat 10 has a length L on the order of 12 meters; the boat 10 is referred to colloquially as being a “40-foot” boat. The drive units 30, 50 are mounted a distance d₂ apart, wherein the distance d₂ is on the order of 1.5 meters for the boat 10. Moreover, the drive units 30, 50, in a longitudinal direction along the boat 10, are mounted a distance d₁ from the aforementioned geometrical center C, wherein the distance d₁ is on the order of 3.5 meters to 4 meters for the boat 10. However, the boat 10 can be of other physical dimensions.

The boat 10 further includes a control unit 70 coupled in communication with the engines and drive units 30, 50 for controlling gear shift, engine power and angular orientation of the rudders 34, 54 relative to the hull 20. Gear shift control involves engaging in forward, reverse or neutral. The control unit 70 is also coupled in communication with a steering console 80 from which user operation commands are provided to the control unit 70. The steering console 80 includes a user-rotatable steering wheel 90 and a lever arrangement 100. The steering wheel 90 is coupled to a rotation sensor which senses an angular position of the wheel 90 to generate a steering command signal for transmission to the control unit 70. The lever arrangement 100 includes one or more levers for controlling average power delivered by the engines to their propellers 32, 52, and for commanding gear shifts for the drive units 30, 50.

Operation of the boat 10 will now be described to place the present invention into context. When the boat 10 is being driven by its user in a forward direction, that is, straight ahead, both engines are commanded by the user via the steering console 80 to deliver substantially equal power to their propellers 32, 52, respectively. The propellers 32, 52 are of nominally similar size and design and both propellers 32, 52 contribute to provide a backward directed thrust for propelling the boat 10 in the forward direction. Moreover, the engines are also preferably of similar design and size. Additionally, both drive units 30, 50 are implemented so that the propellers 32, 52 respectively rotate in mutually opposite directions so as not to cause any bias in a forward path of the boat 10. For the forward direction, the rudders 34, 54 are adjusted using the steering wheel 90 to be substantially aligned to the axes 40, 60 respectively.

When the user desires to steer the boat 10 in a gradual manner from such a forward path to implement a relatively wide turn, the user rotates the steering wheel 90 which results in commands being transmitted to the control unit 70 which, in consequence, causes actuators associated with the rudders 34, 54 to pivot the rudders 34, 54 in synchronism, for example as illustrated in FIG. 1 in dotted outline, to cause the boat 10 to gradually turn.

When the boat 10 is being used to hunt big fish, the boat 10 is typically operated with a first person at the steering console 80 steering the boat 10 and a second person at the stern region for operating winches and similar apparatus for landing the big fish onboard the boat 10. Because big fish are physically strong, it is desirable that the first person or pilot controls orientation of the boat 10 promptly in relation to the big fish otherwise there is a risk that the big fish would cause the boat to roll over on its side with an associated risk of capsizing or sinking. The pilot attempts to maneuver the boat 10 so that the stern region of the hull 20 faces towards the big fish which largely prevents the boat 10 from rolling laterally to port-side or starboard as the big fish struggles.

One form of maneuver which is especially beneficial when attempting to catch big fish is to try to maintain the big fish on a port-side/stern of the boat 10 while turning the boat 10 substantially about its geometric center C. Such a turn will be referred to as a “tight left” turn. Such a tight left turning maneuver is achieved by using the lever arrangement 100 to shift the first drive unit 30 into reverse and the second drive unit 50 into forward gear. In such a mode of operation, the propellers 32, 52 rotate in a mutually similar direction. In consequence the propeller 32 develops longitudinal and lateral components of thrust 120, 140 respectively as illustrated in FIG. 1. The propeller 34 develops longitudinal and lateral components of thrust 130, 150 respectively also as illustrated in FIG. 1. The lateral components of thrust 140, 150 are directed in mutually similar directions and combine cooperatively to propel the boat 10 stern laterally to starboard when performing the tight left turn. Moreover, the longitudinal components of thrust 120,130 are in mutually opposite directions but offset by the distance d₂ to cause the boat 10 to turn in a counterclockwise manner about the geometrical center C as denoted by arrow 160.

Similar considerations pertain when a tight right turn is required wherein the first drive unit 30 is configured in a forward gear and the second drive unit 50 is configured in a reverse gear for causing the boat 10 to rotate in a clockwise manner about the geometrical center C.

Such a combination of both lateral and rotation movement of the boat 10 is regarded by expert fishermen to be highly desirable for maintaining a struggling big fish at a stern of the boat 10.

More recently, dual counter-rotating duo-prop propellers, for example in a manner as described in a published international PCT patent application no. WO 2004/074089 (PCT/SE2004/000206) (Volvo Penta AB), have become popular in that, for a given size of propeller assembly, they are capable of generating more thrust. Such counter-rotating propellers are either configured in pushing mode or in traction mode depending upon implementation.

The boat 10 in FIG. 1 may be equipped with such dual counter-rotating propellers to provide a boat as shown in FIG. 2, wherein the boat is indicated generally by 300. The boat 300 is similar to the boat 10 except that the propellers 32, 52 are replaced by corresponding counter-rotating duo-prop propellers 332, 352 respectively. In addition, the first and second drive units 30, 50 are replaced by drive units 330, 350, which are pivotally mounted to the hull 20 and pivot about axes 340, 360 respectively. The rudders 34, 54 are optionally omitted. The drive units 330, 350 and their associated duo-prop propeller assemblies are rotated in synchronism in response to user rotation of the steering wheel 90.

When performing a tight left turn about the geometrical center C as illustrated in FIG. 2, the first drive unit 330 is shifted into reverse gear, and the second drive unit 350 is shifted into forward gear using the lever arrangement 100. Simultaneously, the user turns the steering wheel 90 to rotate both drive units 330, 350 so that their duo-prop propellers 332, 352 face towards starboard. Such a mode of operation causes the boat 300 to rotate in an anticlockwise manner as denoted by the arrow 160 in FIG. 2. However, the aforementioned lateral components as obtained from the boat 10 when performing a tight turn are not obtained for the boat 300 on account of its use of duo-prop dual counter-rotating propellers. Thus, although the boat 300 is more powerful and responsive in certain respects to the boat 10, and the boats 10, 300 are of substantially mutually similar size, the boat 300 nevertheless lacks the aforesaid lateral movement which is highly beneficial when catching powerful big fish.

It is thus desirable to try to employ counter-rotating duo-prop propellers in the boat 300 simultaneously with achieving a lateral component of thrust when performing tight turns. Lack of such a lateral component represents a technical problem which the present invention seeks to address.

### SUMMARY OF THE INVENTION

An object of the present invention is to provide a method of maneuvering aquatic vessels which provides a beneficially useful combination of rotational movement and lateral sideways lateral movement.

According to a first aspect of the invention, there is provided a method of maneuvering an aquatic vessel,

the vessel including at least one hull and at least one engine, the at least one engine including at least one output rotationally couplable to a plurality of corresponding propeller units having drives which are mounted so as to be angularly moveable with respect to the at least one hull, the aquatic vessel including a control unit for controlling operation of the at least one engine and angles of the propeller units with respect to the at least one hull, the aquatic vessel being configurable to operate in a first mode wherein directions of thrust developed by the plurality of propeller units are mutually substantially parallel for propelling the vessel through water,

the method including steps of:
a. user-instructing the control unit to invoke a second mode of operation wherein the directions of thrust developed by the propeller units are controllable to mutually diverge with respect to a longitudinal axis from a rear end of the vessel to a forward end thereof for providing the vessel with a turning characteristic in operation; and
b. controlling rotation of the vessel by controlling power coupled from the at least one engine delivered to the plurality of propeller units and forward/reverse coupling of the propeller units.

The invention advantageously configures the propelling units in such a divergent manner which provides both a rotational and lateral movement of the vessel when operated in the second mode which, for example, is beneficial when hunting for big fish.

Optionally, the method includes a step of orientating the propeller units so that their thrust directions are divergent in the second mode by a divergence angle in a range of 5° to 45° with respect to the longitudinal axis of the vessel passing from its rear end to its forward end. Such a range of angles provides a useful degree of rotation and lateral motion of the vessel when configured in its second mode of operation.

Alternatively, the divergence angle is in a range of 8° to 30° in respect of the longitudinal axis. Yet another alternative is to set the divergence angle in a range of 25° to 28° with respect to the longitudinal axis. A particularly advantageous divergence angle is substantially 26° with respect to the longitudinal axis.

Advantageously, when implementing the method, each propeller unit is coupled to an associated dedicated engine which is independently user controllable in the second mode. Such implementation is highly convenient for obtaining a low center of gravity for the vessel as well as being mechanically more convenient in its implementation; for example, two smaller engines are individually of potentially lower weight than one single larger engine offering similar power output.

Optionally, the method includes a step of user-selecting amongst a plurality of permitted divergent angles for the propeller units via the control unit in the second mode. The user is thereby capable of selecting a divergence angle with which the user is most comfortable.

Optionally, in the method, at least one of the plurality of propeller units is configured to be a dual counter-rotating propeller arrangement. Such dual propellers operable to mutually counter rotate in operation are capable of providing higher magnitudes of thrust for a given propeller size in comparison to single-propeller units.

Optionally, the method is implemented so that the vessel is rotatable substantially about its geometrical center simultaneously with a stern region of the vessel being movable in a lateral direction.

Optionally, according to the method, the plurality of propeller units are orientated so as to be substantially angularly symmetrically disposed about the longitudinal axis when adjusted to be angularly divergent.

Optionally, the method includes a step of coupling a user-operable joy-stick type control in communication with the control unit for controlling operation of the propeller units coupled to the at least one engine in the second mode. Such joy-stick type control is advantageous when quick maneuvering is needed.

Optionally, the method includes a step of coupling a plurality of mutually independently user-adjustable lever controls to the control unit, the plurality of lever controls being operable via the control unit to control power coupled from the at least one engine to their corresponding propeller units. Such lever control is found in practice to be highly user-ergonomic and provides a fine degree of control of the vessel.

Optionally, in the method, the second mode is a “fishing” mode adapted for providing the vessel with a turning characteristic suitable for invoking when the vessel is to be used to catch big fish.

According to a second aspect of the invention, there is provided an aquatic vessel,

the vessel including at least one hull and at least one engine, the at least one engine comprising at least one output rotationally couplable to a plurality of corresponding propeller units which are mounted so as to be angularly moveable with respect to the at least one hull, and a control unit for controlling operation of the at least one engine and angles of the propeller units with respect to the at least one hull, the aquatic vessel being configurable to operate in a first mode wherein directions of thrust developed by the plurality of propeller units are mutually substantially parallel for propelling the vessel through water, and a second mode of operation wherein the directions of thrust developed by the propeller units are configured to mutually diverge in respect of a longitudinal axis from a rear end of the vessel to a forward end thereof for providing the vessel with a turning characteristic in operation, wherein
a. the control unit is configured to receive user-instructions for commanding the control unit to invoke the second mode for causing the propeller units to be angularly orientated in a divergent manner in respect of the longitudinal direction; and
b. the control unit is configured to control rotation of the vessel by controlling power coupled from the at least one engine delivered to the plurality of propeller units and forward/reverse coupling of the propeller units.

Optionally, the propeller units of the aquatic vessel are operable to be orientated so that their thrust directions are divergent in the second mode by a divergence angle in a range of 5° to 45° with respect to a longitudinal axis of the vessel passing from its stern to its forward end.

Alternatively, the divergence angle is in a range of 8° to 30° with respect to the longitudinal axis. Yet another alternative is that the divergence angle is in a range of 25° to 28° in respect of the longitudinal axis. Further, and advantageously, the divergence angle is substantially 26° in respect of the longitudinal axis.

Optionally, in the aquatic vessel, each propeller unit is coupled to an associated engine which is mutually independently user controllable in the second mode.

Optionally, in the aquatic vessel, the plurality of permitted divergent angles for the propeller units are user-selectable via the control unit in the second mode.

Optionally, in the aquatic vessel, at least one of the plurality of propeller units is configured to be a dual counter-rotating propeller arrangement.

Optionally, the vessel in operation is rotatable substantially about its geometrical centre simultaneously with a stern region of the vessel being movable in a lateral direction.

Optionally, the aquatic vessel is implemented such that the plurality of propeller units are orientated so as to be substantially angularly symmetrically disposed about the longitudinal axis when adjusted to be angularly divergent.

Optionally, the aquatic vessel further includes a user-operable joy-stick type control coupled to the control unit for controlling operation of the propeller units coupled to the at least one engine in the second mode.

Optionally, the aquatic vessel is implemented such that a plurality of mutually independently user-adjustable lever controls are coupled to the control unit, the plurality of lever controls being operable via the control unit to control power coupled from the at least one engine to their corresponding propeller units.

Optionally, the aquatic vessel is implemented such that the second mode is a “fishing” mode adapted for providing the vessel with a turning characteristic suitable for invoking when the vessel is to be used to catch big fish, for example mature sharks.

According to a third aspect of the invention, there is provided a software product recorded on a data carrier or conveyable via a signal, the software product being executable on computing hardware of a control unit for implementing a method pursuant to the first aspect of the invention.

According to a fourth aspect of the invention, there is provided propulsion system for an aquatic vessel, the propulsion system being operable according to a method pursuant to the first aspect of the invention.

It will be appreciated that features of the invention are susceptible to being combined in any combination without departing from the scope of the invention as defined by the accompanying claims.

### BRIEF DESCRIPTION OF THE FIGURES

Embodiments of the present invention will now be described, by way of example only, with reference to the accompanying drawings wherein:

FIG. 1 is a schematic illustration in plan view of a boat configured in a conventional manner;

FIG. 2 is a schematic illustration in plan view of the boat of FIG. 1 modified to include pivotally-adjustable drive units and propeller assemblies provided with counter-rotating duo-prop propellers;

FIG. 3 is a schematic illustration of a boat pursuant to the present invention configured in its “fishing mode” wherein the boat is operable to develop not only a turning force but also a lateral force when turning; and

FIGS. 4a and 4b are illustrations of implementations of a joy-stick control suitable for steering the boat of FIG. 3 when configured in its “fishing mode”.

### DETAILED DESCRIPTION OF EMBODIMENTS OF THE INVENTION

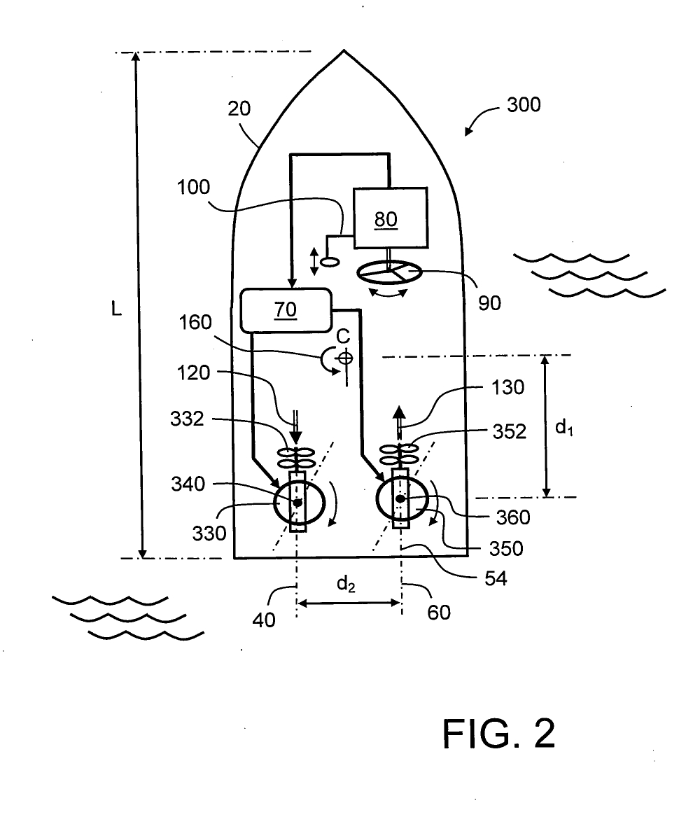

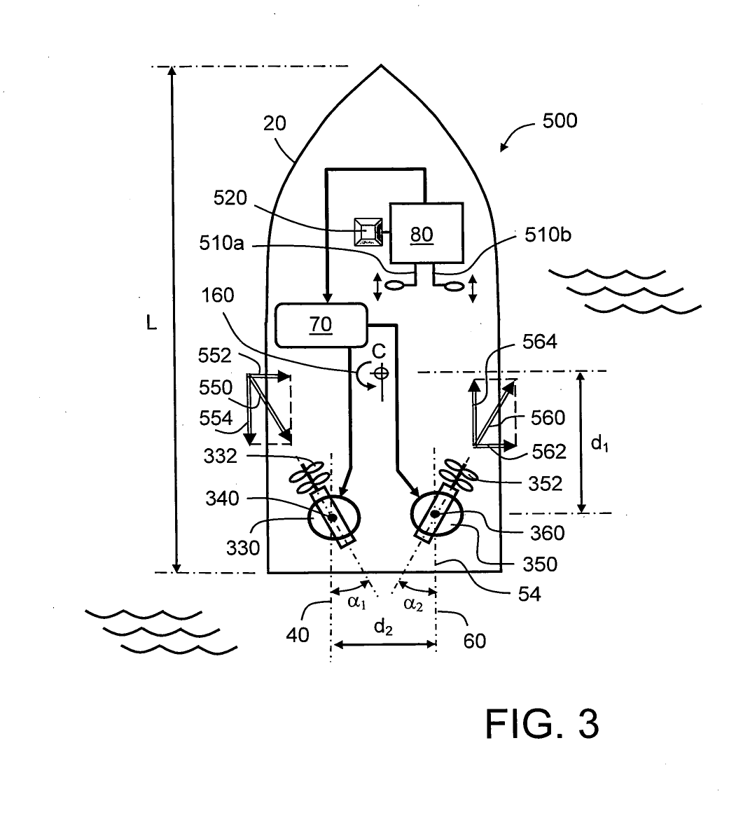

In a boat as configured in FIG. 2, it is conventional practice to pivot the drive units 330, 350 and, accordingly, their associated counter-rotating duo-prop propeller assemblies in synchronism so that their directions of thrust are substantially mutually parallel. The present invention is distinguished from such a conventional approach by appreciating that the boat 300 can be modified, for example by making alterations to the control unit 70, so that the drive units 330, 350 and their associated duo-prop propellers 332, 352 can be configured in an angularly divergent manner as depicted for a boat as illustrated in FIG. 3. In FIG. 3, the boat is indicated generally by 500.

The boat 500 of FIG. 3 differs in several respects in comparison to the boat 300 of FIG. 2. The boat 500 of FIG. 3 includes at the steering console 80 a “fishing mode” control selector 520 which a user can invoke to cause the boat 500 to switch from its normal steering mode to the “fishing mode” when needing to achieve extreme responsiveness from the boat 500 for maintain the stern region orientated in operation towards a big struggling fish. Moreover, the steering console 80 is provided with two lever controls 510a, 510b which are operable to control power delivered by the engines (not illustrated) to their duo-prop propellers 332, 352 respectively. The levers 510a, 510b each have a center position. In addition, the levers 510a, 510b are spring biased towards their center positions. Pushing the levers 510a, 510b forward from the their center positions results in the first and second drive units 330, 350 being coupled in forward gear with the engines delivering progressively more power to their propellers 332, 352 as the levers 510a, 510b are pushed progressively forward. Conversely, pulling the levers 510a, 510b backward from the their center positions results in the first and second drive units 330, 350 being coupled in reverse gear with the engines delivering progressively more power to their propellers 332, 352 as the levers 510a, 510b are pulled progressively backward. The levers 510a, 510b can be mutually independently user manipulated so that one of the drive units 330, 350 can be engaged in reverse gear while another of the drive units can be engaged in forward gear.

When the “fishing mode” control 520 is invoked, the control unit 70 commands the drive units 330, 350 to pivot from a substantially synchronized angular configuration wherein thrusts developed therefrom are in mutually substantially parallel directions, to a divergent angular configuration as depicted in FIG. 3 wherein direction of thrust developed by the propellers 332, 352 respectively are directed in directions which are not mutually parallel. When “fishing mode” is invoked by user operation of the control 520, the drive units 330, 350 are rotated to subtend angles of α₁, α₂ relative to the axes 40, 60 as depicted in FIG. 3; it is to be recalled that the axes 40, 60 are mutually parallel.

Beneficially, the control unit 70 steers the drive units 330, 350 in the aforesaid “fishing” mode so that the angles α₁, α₂ are substantially mutually similar in magnitude. Optionally the angles α₁, α₂ are in a range of 5° to 45°, more preferably in a range of 8° to 30°, and most preferably in a range of 15° to 28°, for example, substantially 260. As illustrated in FIG. 3, invoking the aforesaid “fishing” mode causes direction of thrusts developed by the propellers 332, 352 respectively to be directed away from the geometrical center C. Optionally, the control 520 has multiple settings which are user-selectable for selecting a selection of angles α₁, α₂. For example, the control 520 can have five settings:

a setting “A” corresponding to α₁=−α₂ (normal non-fishing mode, namely “fishing” mode deactivated such that thrusts developed by the propellers 332, 352 are developed in directions which are mutually parallel);

a setting “B” corresponding to α₁, α₂=5° (namely the engines 30, 50 are configured to be divergent as illustrated in FIG. 3);

a setting “C” corresponding to α₁, α₂=10° (the engines 30, 50 being divergent as in FIG. 3);

a setting “D” corresponding to α₁, α₂=18° (the engines 30, 50 being divergent as in FIG. 3), and

a setting “E” corresponding to α₁, α₂=26° (the engines 30, 50 being divergent as in FIG. 3).

Alternatively, the control 520 can be continuously variable and the angles α₁, α₂ servo controlled accordingly to continuous adjustment of the control 520.

In operation in “fishing” mode, as illustrated in FIG. 3, for purposes of executing a tight left turn, the first drive unit 330 is engaged in reverse gear to develop a thrust as denoted by an arrow 550. Moreover, the second drive unit 350 is engaged in forward gear to develop a thrust as denoted by an arrow 560. The thrust as denoted by the arrow 550 has a resolved lateral thrust component as denoted by an arrow 552 and a resolved longitudinal thrust component denoted by an arrow 554. Similarly, the thrust as denoted by the arrow 560 has a resolved lateral component as denoted by an arrow 562 and a resolved longitudinal component as denoted by an arrow 564. It will be appreciated that the resolved thrust components as denoted by the arrows 552, 562 cooperate to generate a lateral thrust to move the boat 500 laterally towards a right-hand side of FIG. 3. Moreover, the resolved thrust components as denoted by the arrows 554, 564 are directed along the axes 40, 60, which are a distance d₂ apart, to cause a rotational moment to be experienced by the boat 500 resulting in it rotating in a counterclockwise manner about the geometrical center C.

Similar considerations pertain when, in “fishing” mode, the first drive unit 330 is engaged in forward gear and the second drive unit 350 is engaged in reverse gear causing the boat to move laterally to a left-hand side of FIG. 3 and rotate about the geometrical center C in a clockwise direction.

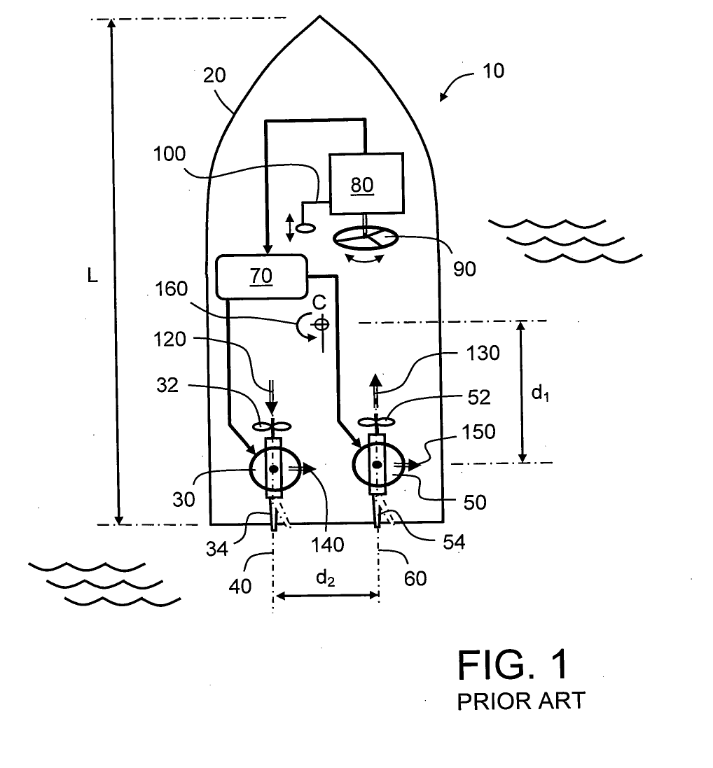

The “fishing” mode is thus capable of providing movement as obtained for the boat 10 illustrated in FIG. 1, simultaneously with duo-prop propellers providing enhanced steering performance when, for example, chasing after and capturing big fish. While in “fishing” mode, the user can operate the controls to move the boat 500 backwards and forwards, and is also able to rotate the boat 500 rapidly about its geometrical center C while simultaneously achieving the desired lateral movement of the boat 500 when turning. Such a high degree of desirable steering control can be achieved without increasing the size and weight of the engines appreciatively.

When implementing the system in a boat 500, its length L is preferably in a range of 8 metres to 20 metres, more preferably in a range of 10 metres to 15 metres, and most preferably substantially 12 metres. The boat 500 optionally has a length corresponding to a boat colloquially known as a “40-foot” boat. The distance d₂ between the drive units for the boat 500 is preferably in a range of 1 meter to 3 meters, more preferable in a range of 1.2 meters to 2 meters, and most preferably substantially 1.5 meters. Moreover, the distance d₁ from the center to the drive units for the boat 500 as illustrated in FIG. 3 is preferably in a range of 2.5 meters to 5 meters, more preferably in a range of 3.5 meters to 4 meters, and most preferably substantially 3.75 meters.

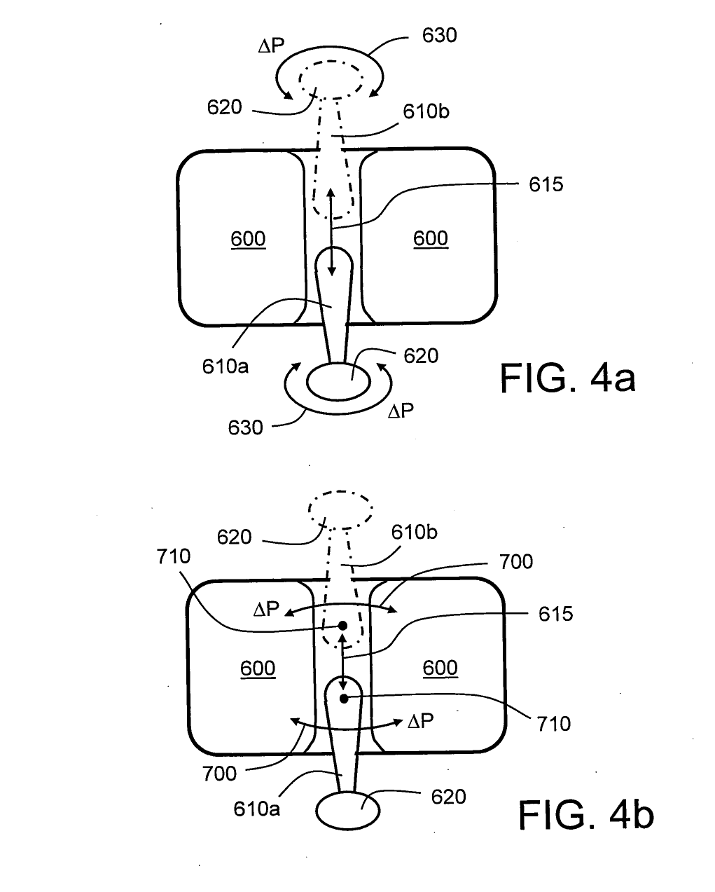

Optionally, the steering console 80 is provided with the steering wheel 90 and its associated control arrangement 100, as shown in FIG. 2, as well as being provided with levers 510a, 510b as shown in FIG. 3 for use when operating the boat 500 in “fishing” mode. As an alternative to employing the levers 510a, 510b to control the boat 500 in “fishing” mode, a joystick-type control can optionally be employed. Referring to FIG. 4a, there is illustrated a first type of joystick control for the steering console 80. The first joystick control comprises a joystick unit 600 including a central slot in which a joystick 610 is user-movable in a forward/backward pivotal movement; forward and reverse positions of the joystick 610 are denoted by 610a, 610b respectively with movement denoted by an arrow 615. The joystick 610 is beneficially spring biased towards its central position so that the boat 500 comes to a standstill if the user is not applying any force to the joystick 610. Position of the joystick 610 in a push/pull direction along the arrow 615 controls average power, namely (P1+P2)/2, demanded from each of the engines to be supplied to their associated one or more propellers.

An end knob 620 at a distal end of the joystick 610 as illustrated is user-rotatable as denoted by an arrow 630. Rotation of the knob 620 is used to control a difference in power ΔP delivered by each engine. Advantageously, rotation of the knob 620 is spring biased so that the knob 620 returns to a central rotational position corresponding to substantially zero difference in power ΔP when the user does not apply any rotational force thereto. When a relatively larger rotation is applied to the knob 620, it can, for example in an extreme case, result in one of the drive units 330, 350 being engaged into forward gear and another of the drive units being engaged into reverse gear to provide the boat 500 with impressive turning and sideways movements in operation.

The joystick control illustrated in FIG. 4a is of benefit in that the user is potentially capable of controlling travel of the boat 500 using just one hand, thereby leaving his/her other hand free to perform other functions, for example controlling winching equipment to hoist a large fish on board the boat 500.

Referring next to FIG. 4b, there is illustrated a second type of joystick control for the steering console 80. The joystick of FIG. 4b is similar to the joystick of FIG. 4a except that the knob 620 in FIG. 4b is not rotatable. Instead, the joystick 610 is FIG. 4b is configured so that it can also be rocked laterally as denoted by an arrow 700 about a pivot point 710, in addition to being movable in the aforesaid push/pull direction as denoted by the arrow 615. In FIG. 4b, movement of the joystick 610 laterally controls the aforesaid difference in power ΔP. Moreover, movement of the joystick 610 in FIG. 4b in the push/pull direction controls average power developed by the engines 30, 50. In certain positions of the joystick 610 of FIG. 4b, one of the drive units 330, 350 is operated in reverse gear while another of the drive units concurrently is operated in a forward gear. Such control enables the user employing one hand to control the boat 500 to enable it to perform impressive turns and sideways movements in operation as well as rapidly changing speed within limitation of the engines to provide propulsion via their one or more propellers.

It will be appreciated that the boat 500 can be provided with a steering wheel in a manner akin to FIG. 1 as well as being provided with control levers or one or more joysticks pursuant to FIG. 3, 4a, 4b. In such an implementation, the control unit 70 is arranged to execute a software product configured so that control is user-switchable between a conventional mode of steering the boat 500 and a method of steering the boat 500 pursuant to the present invention. The software product is beneficially susceptible to being conveyed to the control unit 70 via data carrier, for example an optical data storage disc or solid state memory device, or by way of a signal, for by way of wireless local area network (WLAN) download when the boat 500 is in harbor wherein the harbor is equipped with a WLAN.

Although the present invention has been described in the foregoing in respect of the boat 500 used for catching large fish, the present invention is not limited to use in such a configuration and can be adapted for use with other types of aquatic vessels, for example naval vessels, gunboats and such like. The aforesaid “fishing” mode is also useful when maneuvering the boat 500 in tight confines, for example a crowded harbor, when maneuvering the boat for tethering or un-tethering. Moreover, the present invention is also useful for controlling boats in rough seas when approaching other objects, for example in respect of offshore oil exploration and pilot boats. Modifications to embodiments of the invention described in the foregoing are thus possible without departing from the scope of the invention as defined by the accompanying claims.

The present invention is not limited for use with aquatic vessels having only a single hull. The present invention can be also employed with multi-hulled boats, for example catamaran and trimaran type performance boats. Although two engines and drive units are described, the boat 500 optionally utilized other numbers of engines, for example a single engine couple via dual transmissions to the propeller units 332, 352.

Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural.

Numerals included within parentheses in the accompanying claims are intended to assist understanding of the claims and should not be construed in any way to limit subject matter claimed by these claims.

What is claimed is:

1. A method of maneuvering an aquatic vessel, said vessel including at least one hull and at least one engine, said at least one engine including at least one output rotationally couplable to a plurality of corresponding propeller units which are mounted so as to be angularly moveable in respect of said at least one hull, said aquatic vessel including a control unit for controlling operation of said at least one engine and angles of said propeller units with respect to said at least one hull, said aquatic vessel being configurable to operate in a first mode wherein directions of thrust developed by the plurality of propeller units are mutually substantially parallel for propelling the vessel through water, said method comprising the steps of:
user-instructing the control unit to invoke a second mode of operation wherein said directions of thrust developed by said propeller units mutually diverge angularly with respect to a longitudinal axis from a rear end of the vessel to a forward end thereof for providing the vessel with a turning characteristic; and
controlling rotation of the vessel by controlling power coupled from the at least one engine delivered to said plurality of propeller units and controlling forward/reverse coupling of said propeller units.

2. A method as claimed in claim 1, comprising a step of orientating said propeller units so that their thrust directions are divergent in said second mode by a divergence angle in a range of 5° to 45° with respect to said longitudinal axis of said vessel passing from its rear end to its forward end.

3. A method as claimed in claim 2, wherein the divergence angle is in a range of 8° to 30° with respect to said longitudinal axis.

4. A method as claimed in claim 2, wherein the divergence angle is in a range of 25° to 28° with respect to said longitudinal axis.

5. A method as claimed in claim 2, wherein the divergence angle is substantially 26° with respect to said longitudinal axis.

6. A method as claimed in claim 1, wherein each propeller unit is coupled to an associated engine which is mutually independently user controllable in said second mode.

7. A method as claimed in claim 1, further comprising the step selecting a divergence angle for orientating said propeller units so that their thrust directions are divergent in said second mode with respect to said longitudinal axis of said vessel passing from its rear end to its forward end.

8. A method as claimed in claim 1, wherein at least one of said plurality of propeller units is configured as a dual counter-rotating propeller arrangement.

9. A method as claimed in claim 1, wherein directions of thrust and power coupled to the propellers are controlled so that said vessel is rotates substantially about its geometrical center simultaneously with a stern region of the vessel moving in a lateral direction.

10. A method as claimed in claim 1, wherein the plurality of propeller units are orientated so as to be substantially angularly symmetrically disposed about said longitudinal axis when adjusted to be angularly divergent.

11. A method as claimed in claim 1, including a step of coupling a user-operable joystick type control in communication with said control unit for controlling operation of said propeller units coupled to said at least one engine in said second mode.

12. A method as claimed in claim 1, including a step of coupling a plurality of mutually independently user-adjustable lever controls to said control unit, said plurality of lever controls being operable via said control unit to control power coupled from said at least one engine to their corresponding propeller units.

13. An aquatic vessel, comprising:
at least one hull;
at least one engine;
a plurality of propeller units mounted to be selectably angularly oriented with respect to said at least one hull, and coupled to an output of said at least one engine;
a control unit for controlling operation of said at least one engine and controlling angular orientation of said plurality of propeller units, wherein said control unit has a first mode of operation wherein directions of thrust developed by the plurality of propeller units are mutually substantially parallel, and a second mode of operation wherein said directions of thrust developed by said propeller units may be mutually divergent in respect of a longitudinal axis from a rear end of the vessel to a forward end thereof for providing the vessel with a turning characteristic in operation;
a user interface operationally connected to said control unit to deliver user-instructions for controlling power coupled from the at least one engine to said plurality of propeller units, controlling forward/reverse coupling of said propeller units, and for commanding the control unit to operate in one of said first mode and said second mode.

14. An aquatic vessel as claimed in claim 13, wherein said propeller units are operable to be orientated so that their thrust directions are divergent in said second mode by a divergence angle in a range of 5° to 45° with respect to said longitudinal axis of said vessel passing from its rear end to its forward end.

15. An aquatic vessel as claimed in claim 14, wherein the divergence angle is in a range of 8° to 30° with respect to said longitudinal axis.

16. An aquatic vessel as claimed in claim 14, wherein the divergence angle is in a range of 25° to 28° with respect to said longitudinal axis.

17. An aquatic vessel as claimed in claim 14, wherein the divergence angle is substantially 26° with respect to said longitudinal axis.

18. An aquatic vessel as claimed in claim 13, wherein each propeller unit is coupled to an associated engine and wherein each associated engine which is mutually independently user controllable in said second mode.

19. An aquatic vessel as claimed in claim 13, wherein said user interface is connected to provide a user instruction selecting a divergent angle for said direction of thrust of said propeller units in said second mode.

20. An aquatic vessel as claimed in claim 13, wherein at least one of said plurality of propeller units comprises a dual counter-rotating propeller arrangement.

22. An aquatic vessel as claimed in claim 13, wherein said vessel in said second mode is rotatable substantially about its geometrical center simultaneously with a stern region of the vessel being movable in a lateral direction.

23. An aquatic vessel as claimed in claim 13, wherein said plurality of propeller units are angularly orientated to be substantially angularly symmetrical about said longitudinal axis.

24. An aquatic vessel as claimed in claim 13, wherein said user interface comprises a user-operable joystick type control for controlling operation of said propeller units.

25. An aquatic vessel as claimed in claim 13, wherein said user interface comprises a plurality of mutually independently user-adjustable lever controls, said plurality of lever controls being operable to control power coupled from said at least one engine to the plurality of propeller units.

26. A software product recorded on a data carrier or conveyable via a signal, said software product being executable on computing hardware of a control unit (70) for implementing a method as claimed in claim 1.

27. A propulsion system for an aquatic vessel, said propulsion system comprising:
a plurality of propeller units mounted to be selectably angularly oriented with respect to said at least one hull, and coupled to an output of said at least one engine;
a control unit for controlling operation of at least one engine and controlling angular orientation of said plurality of propeller units, wherein said control unit has a first mode of operation wherein directions of thrust developed by the plurality of propeller units are mutually substantially parallel, and a second mode of operation wherein said directions of thrust developed by said propeller units may be mutually divergent in respect of a longitudinal axis from a rear end of the vessel to a forward end thereof for providing the vessel with a turning characteristic in operation;
a user interface operationally connected to said control unit to deliver user-instructions for controlling power coupled from the at least one engine to said plurality of propeller units, controlling forward/reverse coupling of said propeller units, for commanding the control unit to operate in one of said first mode and said second mode, and for controlling an angle of orientation of the propeller units in the second mode.
